(19) United States
(12) Patent Application Publication
(10) Pub. No.: US 2003/0055703 A1
(43) Pub. Date: Mar. 20, 2003

(54) Training portal service apparatus, training portal service method, portable storage medium, and computer data signal

(75) Inventor: Kazuo Kashima, Tokyo (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/032,013

(22) Filed: Dec. 31, 2001

(30) Foreign Application Priority Data
Aug. 31, 2001 (JP) 2001-263470

(51) Int. Cl. G06F 17/60

(52) U.S. Cl. 705/8

(57) ABSTRACT

Mediation of receiving an application for training is provided between a client organization to which an applicant for training belongs and a training organization which provides a training service so that the applicant for training can easily select an appropriate training course. The similarity levels between plural pieces of training application information about the client organization and one or more pieces of standard training information, and the similarity levels between the standard training information and plural pieces of training reception information about the training organization which provides training services are obtained and stored. The applicant for training is allowed to select any of the plural pieces of standard training information having higher similarity levels to the training application information specified by the applicant for training, and is allowed to select one of the plural pieces of training reception information having higher similarity levels to the selected standard training information.

### BACKGROUND OF THE INVENTION

1. Field of the Invention

The present invention relates to a training portal service system for mediation of receiving an application for training, and more specifically to a training portal service apparatus and a training portal service method capable of connecting a training application system of a client organization, for example, a plurality of client companies to which an applicant for training to the reception systems of a training organization, for example, a plurality of training service companies which provide a training service through a network.

2. Description of the Related Art

There has been an increasing number of companies providing training services. These companies are hereinafter referred to as training companies. A company, to which employees receiving such training services belong, (hereinafter referred to as a client company) generally has a training application system, and issues an application for training to the training reception system of a training company which receives the application through Internet.

Conventionally, an employee of a client company, that is, an applicant for training, individually contacts a plurality of training companies to select an appropriate training course from among various courses provided by a number of training companies, thereby taking laborious processes and a long time.

Additionally, a training company has the problem that the company can accept an applicant who has contacted the company, but cannot always successfully receive requests from a number of applicants who actually request to receive the courses of the company.

### SUMMARY OF THE INVENTION

The present invention aims at allowing an applicant for training to select an appropriate training course by providing a training portal service apparatus, a training portal service method, a portable storage medium, and a computer data signal for the mediation of receiving an application for training between the applicant for training and a training company so that both client company and training company can be satisfied.

The training portal service apparatus according to the first embodiment of the present invention is based on the mediation of receiving an application for training between a client organization to which an applicant for training belongs and a training organization which provides a training service. The apparatus includes a first similarity level storage unit, a second similarity level storage unit, and a training mediation unit.

The first similarity level storage unit stores a first similarity level indicating the similarity level between one or more pieces of training application information about the client organization and plural pieces of standard training information about the training portal service apparatus.

The second similarity level storage unit stores a second similarity level indicating the similarity level between the plural pieces of standard training information and plural pieces of training reception information about the training organization.

The training mediation unit allows the applicant for training to select any of the plural pieces of standard training information having a higher first similarity level with the training application information about the client organization specified by the applicant for training, and allows the applicant for training to select any of the plural pieces of training reception information about the training organization having a higher second similarity level with the selected standard training information. The above mentioned first and second similarity levels can be obtained in, for example, a data mining method.

The training portal service apparatus according to the present invention can further include a similarity level computation unit for obtaining the importance level of each of the words respectively contained in the above mentioned training application information, standard training information, and training reception information, and obtaining the first and second similarity levels based on the importance levels of the words.

The training portal service apparatus according to the second embodiment of the present invention is based on the mediation of receiving an application for training between a client organization to which an applicant for training belongs and a training organization which provides a training service. The apparatus includes a similarity level storage unit and a training mediation unit.

The similarity level storage unit stores a similarity level between one or more pieces of training application information about the client organization and plural pieces of training reception information about the client organization.

The training mediation unit allows the applicant for training to select any of the plural pieces of training reception information about the training organization having a higher similarity level with the training application information about the client organization specified by the applicant for training.

The training portal service method according to the first embodiment of the present invention is based on the mediation of receiving an application for training between a client organization to which an applicant for training belongs and a training organization which provides a training service. The method computes a first similarity level indicating the similarity level between one or more pieces of training application information about the client organization and plural pieces of standard training information, computes a second similarity level indicating the similarity level between the plural pieces of standard training information and plurality of pieces of training reception information about the training organization, allows the applicant for training to select any of the plural pieces of standard training information having a higher first similarity level with the training application information about the client organization specified by the applicant for training, and allows the applicant for training to select any of the plural pieces of training reception information about the training organization having a higher second similarity level with the selected standard training information.

The training portal service method according to the second embodiment of the present invention is based on the mediation of receiving an application for training between a client organization to which an applicant for training belongs and a training organization which provides a training service. The method computes the similarity level between one or more pieces of training application information about the client organization and plural pieces of training reception information about the training organization, and allows the applicant for training to select any of the plural pieces of training reception information about the training organization having a higher similarity with the training application information about the client organization specified by the applicant for training.

According to the present invention, an employee, etc. of a client organization can easily select one of the training services provided by a plurality of training organizations through a network such as Internet, etc.

In addition, a client organization can select a training service from among a wide selection items. Furthermore, it is not necessary for a client organization and a training organization to perform an individual application and reception process for training, thereby largely improving the efficiency of their processes.

The training organization may be able to improve their business without additional advertising activities. Furthermore, although it has conventionally been necessary to develop and provide an exclusive training course reception system for each client organization, these processes are not required according to the present invention, thereby reducing the cost of developing and maintaining a system.

### BRIEF DESCRIPTION OF THE DRAWINGS

FIG. 1 is a block diagram of the configuration showing the principle of the training portal service apparatus according to the present invention;

FIG. 2 shows a basic process according to the training portal service system according to the first embodiment of the present invention;

FIG. 3 is a block diagram of the configuration of the system according to the first embodiment of the present invention;

FIG. 4 is a flowchart of the process at the preparation stage according to the first embodiment of the present invention;

FIG. 5 is a flowchart of the process at the execution stage according to the first embodiment of the present invention;

FIG. 6 shows an example of a course application screen display according to the present invention;

FIG. 7 shows an example of the contents of the course application reception standard information;

FIG. 8 shows an example of the information about a client company application system;

FIG. 9 shows an example of the contents of a course application standard individual conversion table;

FIG. 10 shows an example of the contents of the information about a training company reception system;

FIG. 11 shows an example of the contents of a course reception standard individual conversion table;

FIG. 12 is a flowchart of the process of selecting a course according to the first embodiment of the present invention when there is no category to be selected in the information about an application system;

FIG. 13 shows an example of a screen display according to a flowchart shown in FIG. 12;

FIG. 14 shows an example of an entry screen display of the information about the training company reception system;

FIG. 15 is a detailed flowchart of the process of computing a similarity level;

FIG. 16 shows an example of the contents of a course table;

FIG. 17 shows an example of the contents of a word table;

FIG. 18 shows an example of the contents of a word occurrence frequency table of each course (text);

FIG. 19 shows an example of the contents of a word importance level table;

FIG. 20 shows an example of the contents of a text relativeness level table;

FIG. 21 shows an example of the contents of a course similarity level table;

FIG. 22 is a flowchart of the basic process according to the second embodiment of the present invention;

FIG. 23 is a block diagram of the configuration of the system according to the second embodiment of the present invention;

FIG. 24 is a flowchart of the preparation stage according to the second embodiment of the present invention;

FIG. 25 is a flowchart of the execution stage according to the present invention;

FIG. 26 shows an example of a training application screen display according to the second embodiment of the present invention;

FIG. 27 shows an example of the contents of a necessary information item table;

FIG. 28 shows an example of the contents of a course application reception individual conversion table;

FIG. 29 is a block diagram of the configuration of a computer executing a program for realizing the present invention;

### DESCRIPTION OF THE PREFERRED EMBODIMENTS

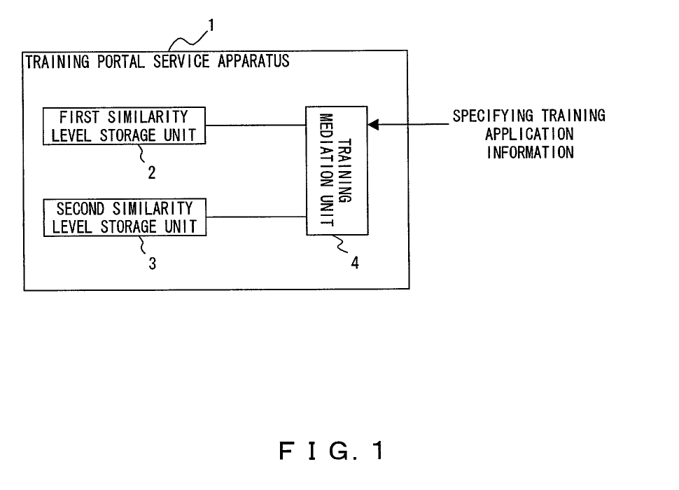

FIG. 1 is a block diagram of the configuration showing the principle of the training portal service apparatus. That is, FIG. 1 is a block diagram of the configuration showing the principle of the training portal service apparatus which provides the mediation of receiving an application for training between a client organization, for example, a client company to which an applicant for training belongs and a training organization, for example, a training company which provides a training service.

A first similarity level storage unit 2 stores a first similarity level between one of more pieces of training application information about a client organization, for example, the information about a plurality of client company courses and plural pieces of standard training information about a training portal service apparatus 1, for example, the information about the contents of a standard course. A second similarity level storage unit 3 stores a second similarity level between plural pieces of standard training information and plural pieces of training reception information about the training organization, for example, the information about the contents of a training course.

A training mediation unit 4 allows an applicant for training to select any of the plural pieces of standard training information having a higher first similarity level with the training application information specified by the applicant for training in the standard training information whose first similarity level is stored in the first similarity level storage unit 2. Then, it allows the applicant for training to select any of the plural pieces of training reception information having a higher similarity level with the selected standard training information in the training reception information whose second similarity level is stored in the second similarity level storage unit 3.

According to the embodiments of the present invention, the training portal service apparatus can further comprise a similarity level computation unit for obtaining the importance levels of words respectively contained in the training application information, the standard training information, and the training reception information, and obtaining a similarity level using the importance levels.

The training portal service apparatus according to the present invention can also be configured by a similarity level storage unit and a training mediation unit.

The similarity level storage unit stores a similarity level between one or more pieces of training application information about a client organization and plural pieces of training reception information about a training organization.

The training mediation unit allows an applicant for training to select any of the plural pieces of training reception information having a higher similarity level with the training application information specified by the applicant for training in the standard training information whose similarity level is stored in the similarity level storage unit.

With the above mentioned configuration, the training portal service apparatus can further comprise the similarity level computation unit.

A method according to the present invention computes a first similarity level between one or more pieces of training application information about a client organization and plural pieces of standard training information, computes a second similarity level between the plural pieces of standard training information and plurality of pieces of training reception information about a training organization, allows an applicant for training to select any of the plural pieces of standard training information having a higher first similarity level with the training application information about the client organization specified by the applicant for training, and allows the applicant for training to select any of the plural pieces of training reception information about the training organization having a higher second similarity level with the selected standard training information.

A computer-readable storage medium according to the present invention stores a program used to direct a computer to perform the steps of computing a first similarity level between one or more pieces of training application information about a client organization and plural pieces of standard training information, computing a second similarity level between the plural pieces of standard training information and plurality of pieces of training reception information about a training organization, allowing an applicant for training to select any of the plural pieces of standard training information having a higher first similarity level with the training application information about the client organization specified by the applicant for training, and allowing the applicant for training to select any of the plural pieces of training reception information about the training organization having a higher second similarity level with the selected standard training information.

A program according to the present invention is used to direct a computer to perform the procedures of computing a first similarity level between one or more pieces of training application information about a client organization and plural pieces of standard training information, computing a second similarity level between the plural pieces of standard training information and plurality of pieces of training reception information about a training organization, allowing an applicant for training to select any of the plural pieces of standard training information having a higher first similarity level with the training application information about the client organization specified by the applicant for training, and allowing the applicant for training to select any of the plural pieces of training reception information about the training organization having a higher second similarity level with the selected standard training information.

An embodiment of the training portal service method according to the present invention can also compute the similarity level between one or more pieces of training application information about a client organization and plural pieces of training reception information about a training organization, and allow the applicant for training to select any of the plural pieces of training reception information about the training organization having a higher similarity with the training application information about the client organization specified by the applicant for training.

An embodiment of the computer-readable storage medium according to the present invention can store a program used to direct a computer to perform the steps of computing the similarity level between one or more pieces of training application information about a client organization and plural pieces of training reception information about a training organization, and allowing the applicant for training to select any of the plural pieces of training reception information about the training organization having a higher similarity with the training application information about the client organization specified by the applicant for training.

A further embodiment of the program of the present invention is used to direct a computer to perform the procedures of computing the similarity level between one or more pieces of training application information about a client organization and plural pieces of training reception information about a training organization, and allowing the applicant for training to select any of the plural pieces of training reception information about the training organization having a higher similarity with the training application information about the client organization specified by the applicant for training.

As described above, the present invention provides a training portal service system for mediation of receiving an application for training between a client company and a training company.

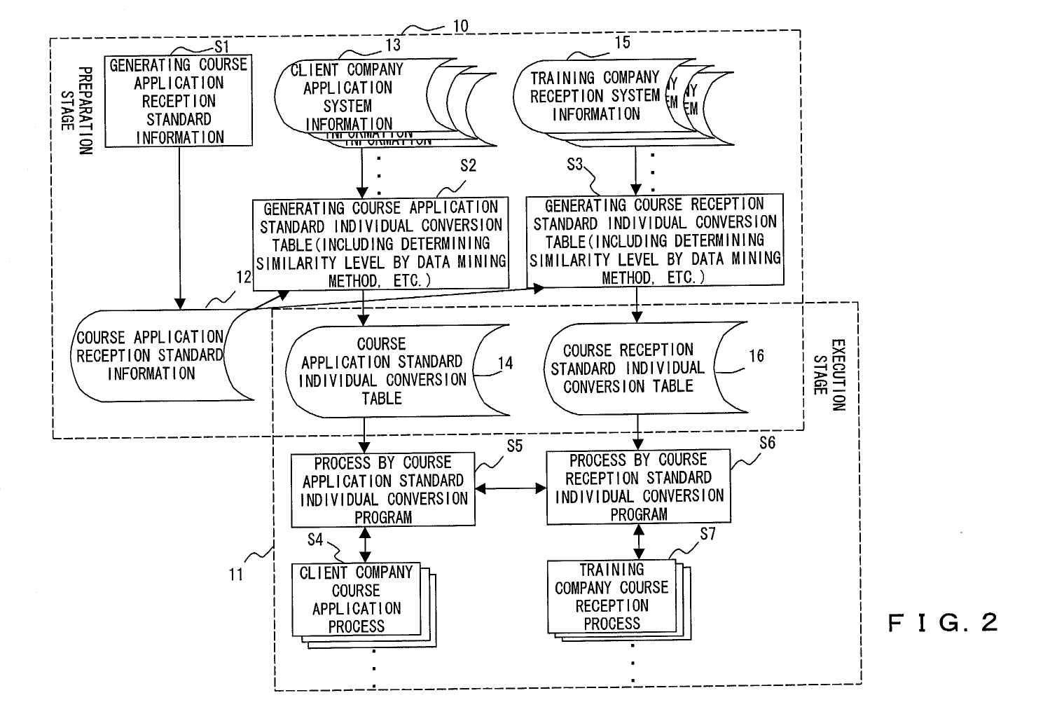

FIG. 2 shows the basic process according to the first embodiment of the present invention.

That is, FIG. 2 shows the basic process performed by the training portal service apparatus separately at a preparation stage 10 and an execution stage 11.

At the preparation stage 10, before an applicant for training belonging to a client organization, for example, a client company actually specifies the training application information corresponding to an application for training, the standard training information is generated, the similarity level between the training application information and the standard training information is computed, the similarity level between the standard training information and the training reception information is computed, etc.

First, in the process of generating a course application reception standard information 12 in step S1, course application reception standard information 12 corresponding to the standard training information is generated. The information relates to the title, the summary, the object of each course prepared by the training portal service apparatus as a standard course of the training portal service apparatus, and the details are described later.

Then, in step S2, the process of generating a course application standard individual conversion table is performed using a client company application system information 13 and the course application reception standard information 12 corresponding to the training application information. The client company application system information 13 relates to the information indicated to each course about the course title of a training course, the summary, the object, etc. to be preferably provided by the client company for an employee.

A course application standard individual conversion table 14 shows the correspondence between the course in the course application reception standard information 12 and the course in the client company application system information 13, and also shows the similarity level between corresponding courses. A similarity level is determined in the data mining method, etc. as described later, and the course application standard individual conversion table 14 is generated as a result.

In the last process of the preparation stage 10, the process of generating a course reception standard individual conversion table is performed. In this process, a course reception standard individual conversion table 16 is generated according to training company reception system information 15 and course application reception standard information 12.

The training company reception system information 15 shows the title, summary, object, period, price, etc. of each training course prepared by a training company. The information about each course is compared with the information about each course in the reception standard information 12. As described later, the course reception standard individual conversion table 16 showing the correspondence between a standard course and a training course, and the similarity level between the courses is generated. A similarity level is determined in the data mining method, etc. as described above.

The process at the execution stage 11 is started by an applicant for training who belongs to a client company and specifies any of a plurality of client company courses prepared for the employees by the client company normally according to plural pieces of training application information, that is, the client company application system information 13 to perform the client company course application process in step S4.

Corresponding to the application process, the process is performed by the course application standard individual conversion program in step S5. In this process, the course application standard individual conversion table 14 is searched, a course having a higher similarity level in the standard courses corresponding to the client company courses for the training application information specified by the applicant for training is sequentially displayed to the applicant in order from the highest similarity level, and the applicant selects any of the standard courses.

Then, in step S6, the process is performed by the course reception standard individual conversion program. In this process, the course reception standard individual conversion table 16 is referred to, and a course having a higher similarity level in the training courses corresponding to the standard course selected by the applicant for training is sequentially displayed, the applicant for training selects any of them, and the training company providing the selected training course performs the training company course reception process is performed in step S7.

The client company course application process in step S4 at the execution stage 11 is actually performed by a server of a client company, and the training company course reception process in step S7 is performed by a server of a training company. However, in the explanation, they are described as the processes relating to the execution stage 11.

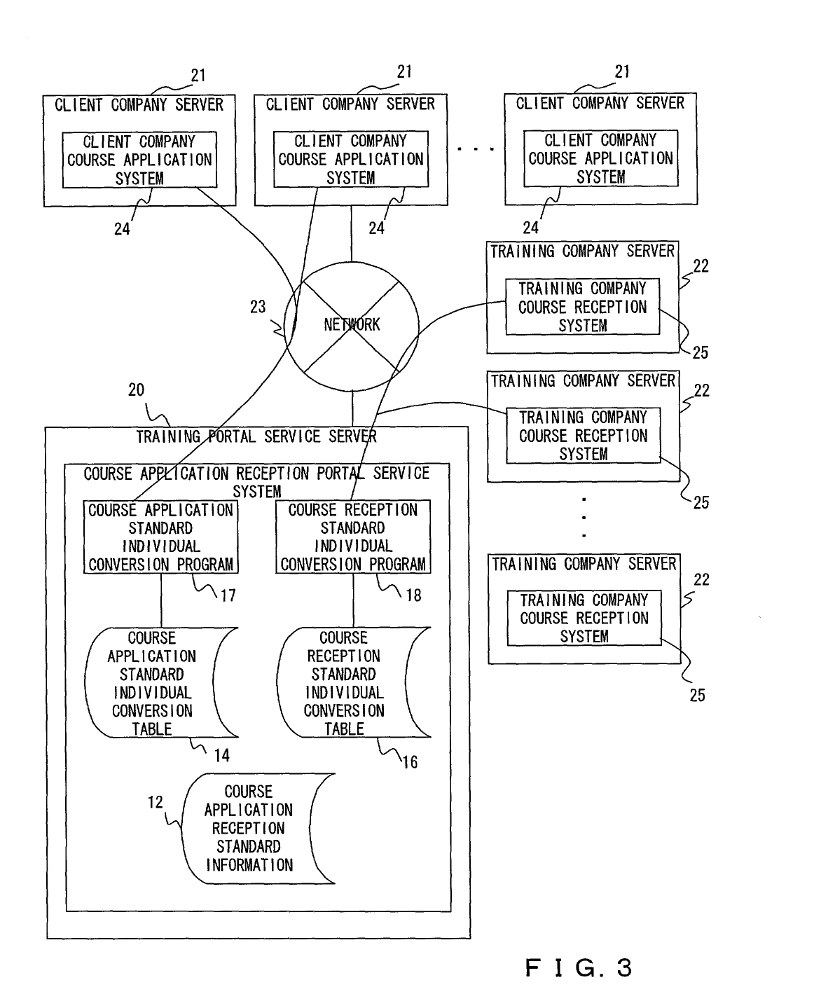

FIG. 3 shows the configuration of the system according to the first embodiment of the present invention.

In FIG. 3, the training portal service system is configured by a training portal service server 20, a client company server 21 of each company, a training company server 22 of a training company, and a network 23 for interconnecting these servers, for example, Internet.

The training portal service server 20 is provided with a training application reception portal service system, and the system comprises the course application reception standard information 12, the course application standard individual conversion table 14, and the course reception standard individual conversion table 16 shown in FIG. 2.

The system also comprises: a course application standard individual conversion program 17 for performing the process in step S5 shown in FIG. 2 together with a client company course application system 24 in each client company server 21 for performing the client company course application process in step S4 shown in FIG. 2; and a course reception standard individual conversion program 18 for performing the process in step S6 together with a training company course reception system 25 in each training company server 22 for performing the training company course reception process in step S7.

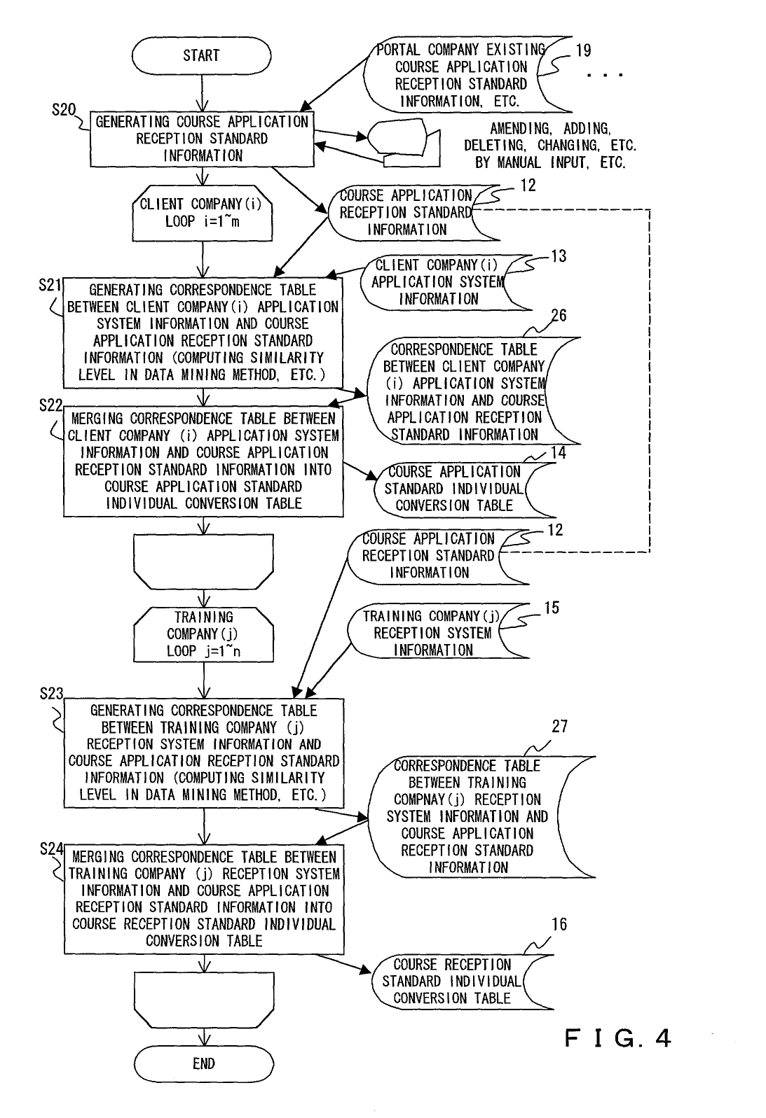

FIG. 4 is a detailed flowchart of the process performed at the preparation stage 10 shown in FIG. 2.

In FIG. 2, when the process is started, the course application reception standard information generation process corresponding to the process in step S1 shown in FIG. 2 is performed in step S20. In this process, information is amended, added, deleted, changed, etc. by manual data entry, etc. according to the course application reception standard information existing in the portal companies for mediation of receiving an application for training, the information relating to new training courses provided by, for example, a training company, etc., thereby generating the latest version of the course application reception standard information 12.

Then, in steps S21 and S22, the course application standard individual conversion table 14 showing the correspondence between the client company course and the standard course, and the similarity level between the courses is generated for each of the client companies (i) (i=1˜m) according to the client company (i) application system information 13. This process is performed for each of the m client companies (i=1˜m).

First, in step S21, a correspondence table 26 between the client company (i) application system information 13 and the course application reception standard information 12 is generated as a result of the similarity level computation performed in the data mining method, etc. Then, in step S22, the correspondence table 26 between the client company (i) application system information 13 and the course application reception standard information 12 is merged, that is, added, to the course application standard individual conversion table 14, thereby terminating the process for the client company (i).

When the process is completed on all client companies, the course reception standard individual conversion table 16 is generated according to the course application reception standard information 12 and the training company (j) reception system information 15 in steps S23 and S24.

As on the client company side, the processes in steps S23 and S24 are performed on each of the client companies (j) (j=1˜n).

First, in step S23, a correspondence table 27 between the training company (j) reception system information 15 and the course application reception standard information 12 is generated by the similarity level computation performed in the data mining method, etc. In step S24, the process of merging the correspondence table 27 into the course reception standard individual conversion table 16, that is, the process of adding the table, is performed. If the course reception standard individual conversion table 16 is generated by including the contents of the training courses of all training companies (j) (j=1˜n), then the process terminates.

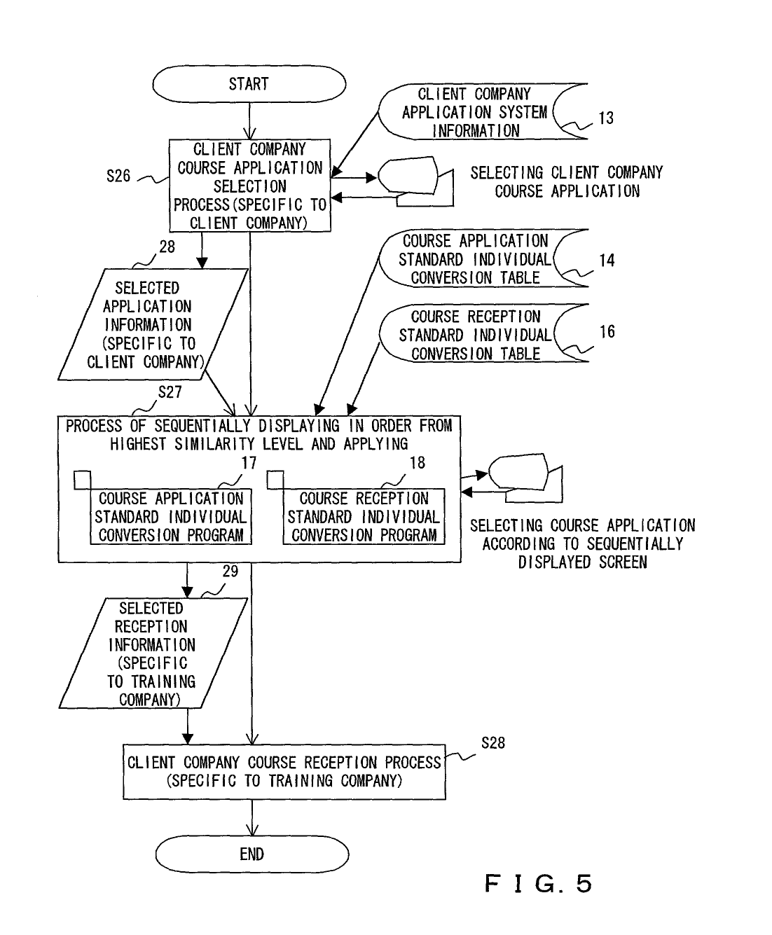

FIG. 5 is a flowchart of the detailed process at the execution stage 11 shown in FIG. 2.

In FIG. 5, when the process starts, a client company course application selection process, which is substantially the same as the process in step S4 shown in FIG. 2, is performed in step S26 on the client company side according to the client company application system information 13. In this process, the titles of the client company courses provided for the application by an employee on the client company are displayed to an applicant for training, and the applicant for training selects one of the courses as application information, and selected application information 28 is provided for the process in step S27 performed by the training portal service server 20 shown in FIG. 3.

In step S27, the process of sequentially displaying the standard courses in order from the highest similarity level, and the application process are performed using the course application standard individual conversion table 14 and the course reception standard individual conversion table 16.

In this process, the process in step S5 shown in FIG. 2, that is, the process performed by the course application standard individual conversion program 17, is first performed. In the standard courses corresponding to the client company courses specified by the selected application information 28, the titles of the courses are sequentially displayed in order from, for example, the highest similarity level, and the applicant for training selects any of the displayed courses. The courses are displayed and selected by the client company server 21 shown in FIG. 3.

Then, the process is performed by the course reception standard individual conversion program 18. In this process, the information about the titles and so forth of the training courses having higher similarity levels, etc. is sequentially displayed in order from, for example, the highest similarity level corresponding to the standard course selected by the applicant for training. The applicant for training selects any of the displayed courses.

The information about the selected training course, that is, selected reception information 29, is provided for the training company course reception process in step S28, and the course requested by the applicant for training is accepted, thereby terminating the process. The process in step S28 is substantially the same as the process in step S7 shown in FIG. 2.

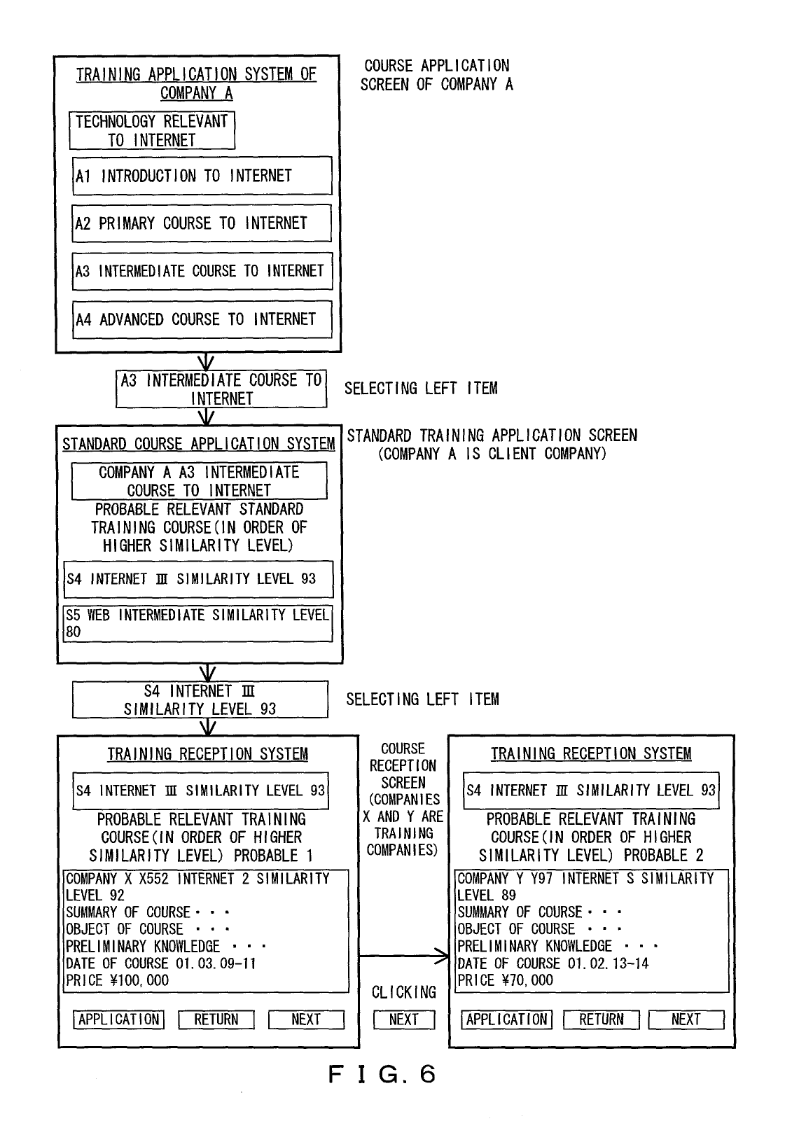

FIG. 6 is an example of the display screen of the client company server 21 shown in FIG. 3 according to the first embodiment. First, the training application screen of the company A, that is, the training application screen specific to the company A (the company A is a client company), is displayed, and the course titles in the training application system of the company A are displayed. In this example, the four course titles belonging to the category ‘Technology relevant to Internet’ is displayed.

When the applicant for training selects a cause having the title of the course ‘Intermediate course to Internet’ and the course code ‘A3’, the titles of the standard courses having higher similarity levels, and the data of the similarity levels, etc. are transmitted to the client company server 21 corresponding to the client company courses selected by the training portal service server 20 shown in FIG. 3. In this example, the two courses, that is, the course having the title ‘Internet III’ and the course code ‘S4’, and the course having the title ‘Intermediate course to WEB’ and the course code ‘S8’, are sequentially displayed in order from the highest similarity level.

When the applicant for training selects the standard course of ‘S4 Internet III’ from between the two courses on the display screen, the data of the training company course having a higher similarity level is transmitted from the training portal service server 20 to the client company server 21 corresponding to the selected standard course.

In this example, the information (the summary of the course, the purpose of the course, etc.) about the course ‘Internet 2’ and the code ‘X552’ of the company X having the highest similarity level of 92 to the course selected from among the standard training courses is displayed as the probable relevant training course 1 on the training reception screen. If the applicant for training clicks the ‘next’ button on the screen to check the next probable relevant training course, then the information about the course ‘Internet S’ and the code ‘Y97’ of the company Y having the second highest similarity level of 89 is displayed as the probable course 2.

The applicant for training clicks the ‘next’ button to display the probable course having the next highest similarity level or clicks the ‘return’ button to display the preceding probable course to display a desired course, and clicks the ‘application’ button with the desired course displayed on the screen to apply for the desired training course.

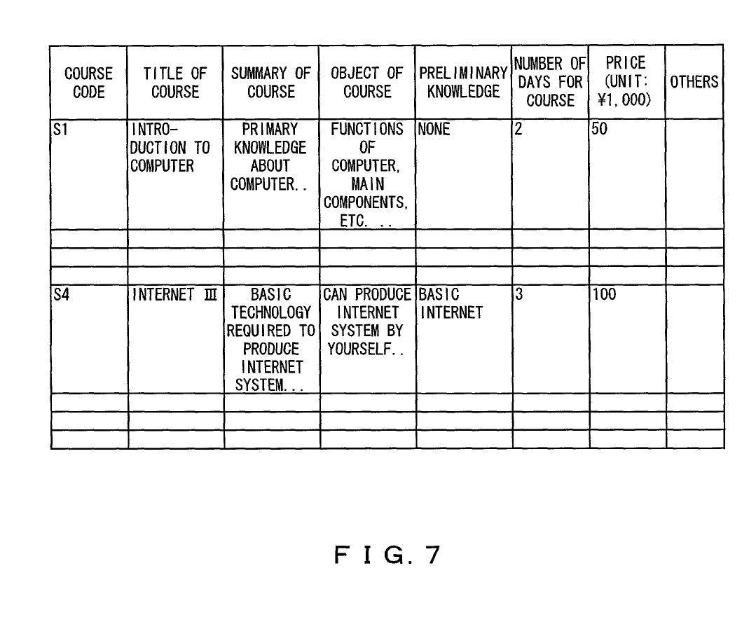

FIG. 7 shows an example of the course application reception standard information 12 shown in FIG. 2. The contents are the information about course codes, titles, summaries, objects, preliminary knowledge, numbers of days for courses, prices, etc.

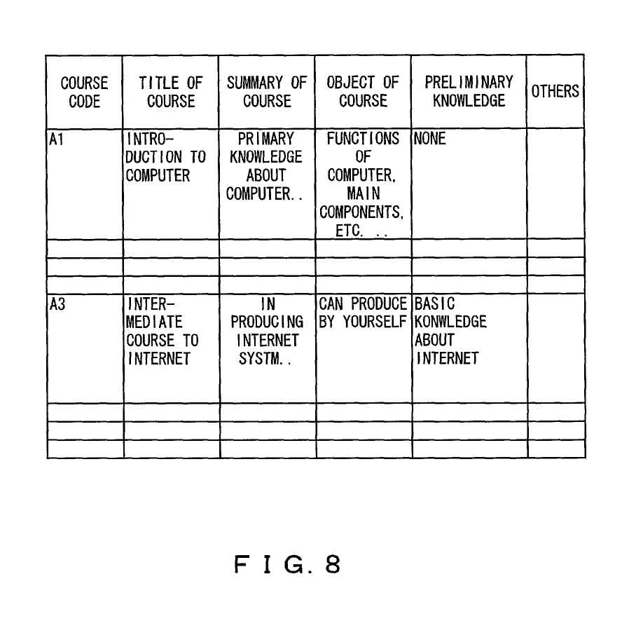

FIG. 8 shows an example of the client company application system information 13. The information is the minimal information for reception of an application from an applicant for training on the client company side, and includes the information about course codes, titles, summaries, objects, preliminary knowledge, etc.

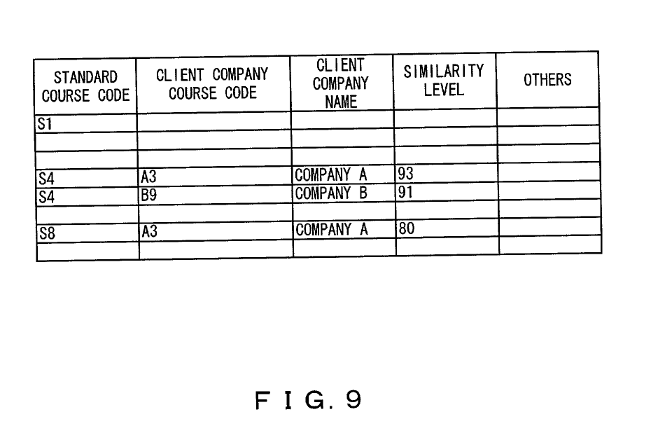

FIG. 9 shows an example of the contents of the course application standard individual conversion table 14. The table stores the information about course codes, names of client companies, similarity levels, etc. relating to the corresponding standard courses and client company courses.

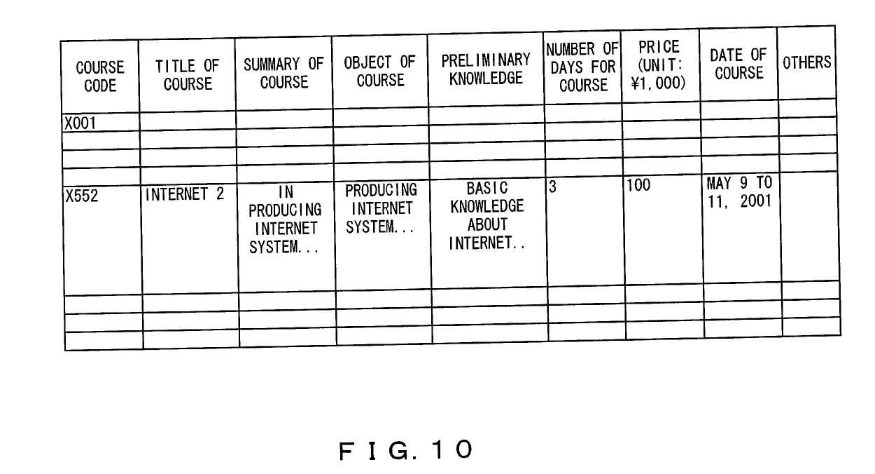

FIG. 10 shows an example of the contents of the training company reception system information 15. The contents are necessary information to select a course about numbers of days for courses, prices, dates of courses, etc. in addition to course codes, titles, summaries, objects, preliminary knowledge, etc.

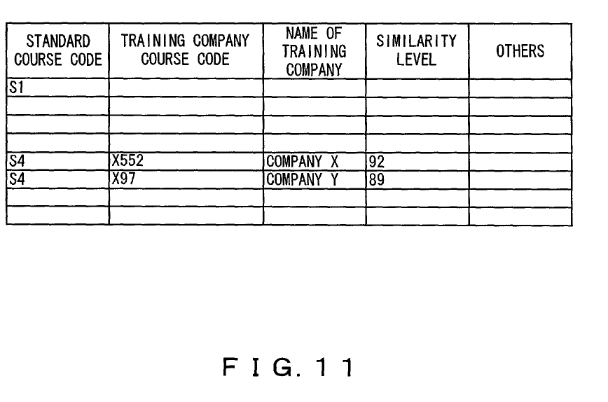

FIG. 11 shows an example of the contents of the course reception standard individual conversion table 16. The table stores the information about course codes, names of training companies, similarity levels, etc. relating to the corresponding standard courses and training company courses.

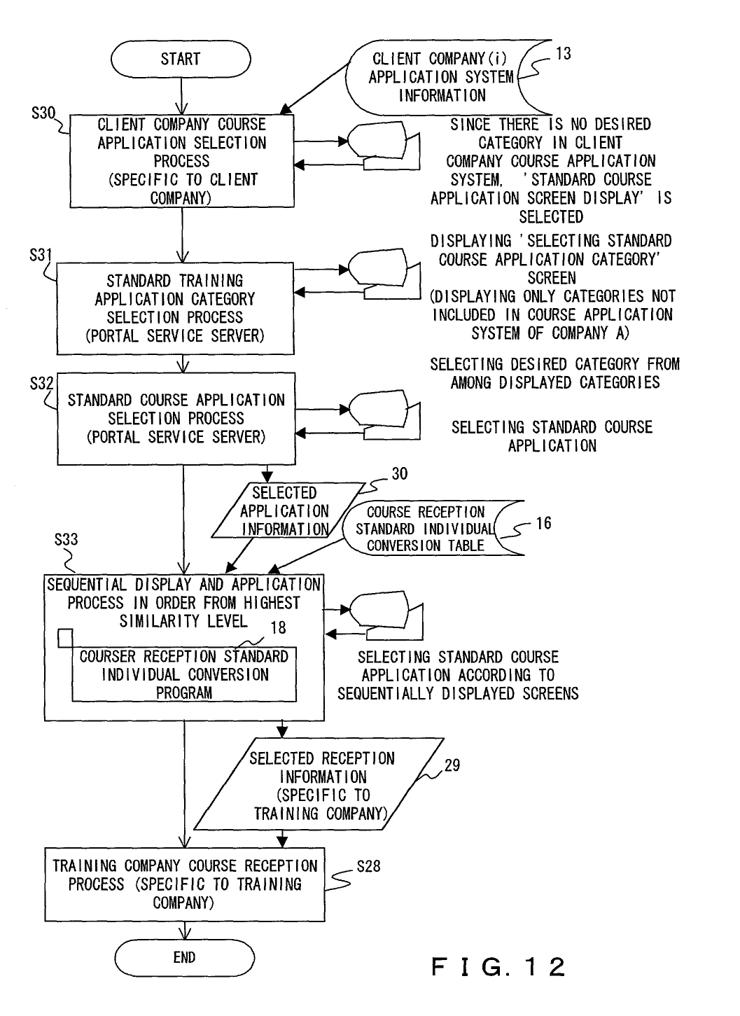

FIG. 12 is a flowchart of the course selection process according to the first embodiment of the present invention when there is no training course desired by an applicant in the client company application system information 13.

Described below is the process performed when there is no training course desired by an applicant for training, for example, the information about the courses of ‘Technology relevant to Internet’ described above by referring to FIG. 6 in the client company application system information 13.

When the process starts as shown in FIG. 12, the client company course application selection process, that is, the process corresponding to step S4 shown in FIG. 2, is first performed in step S30. In this process, since there is no category of the course desired by the applicant for training, the standard course application screen display is selected as described later. Then, in step S31, the standard training application category selection process, in which the standard course application screen is displayed and the applicant for training is allowed to select a category on the display screen, is performed. That is, the standard category prepared by the training portal service server 20 is displayed, and a desired category is selected by the applicant for training.

In step S32, the standard training application selection process is performed. In this process, standard courses belonging to the selected category are displayed, the applicant for training selects a desired course, and selected application information 30 is provided for the process in step S33.

In step S33, the selected application information 30, that is, the training company courses having higher similarity levels to the selected standard course, are displayed in order from the highest similarity level, and the applicant for training is allowed to select a desired course. In this process, the course reception standard individual conversion program 18 sequentially displays the training courses by performing the process similar to the process in step S6 described above by referring to FIG. 2 using the course reception standard individual conversion table 16, allows the applicant for training to select any course, and provides the selected reception information 29 for the process in step S28.

The process in step S28 is, as in the case of step S28 shown in FIG. 5, the same as the process in step S7 shown in FIG. 2, and terminates after performing the training application reception process.

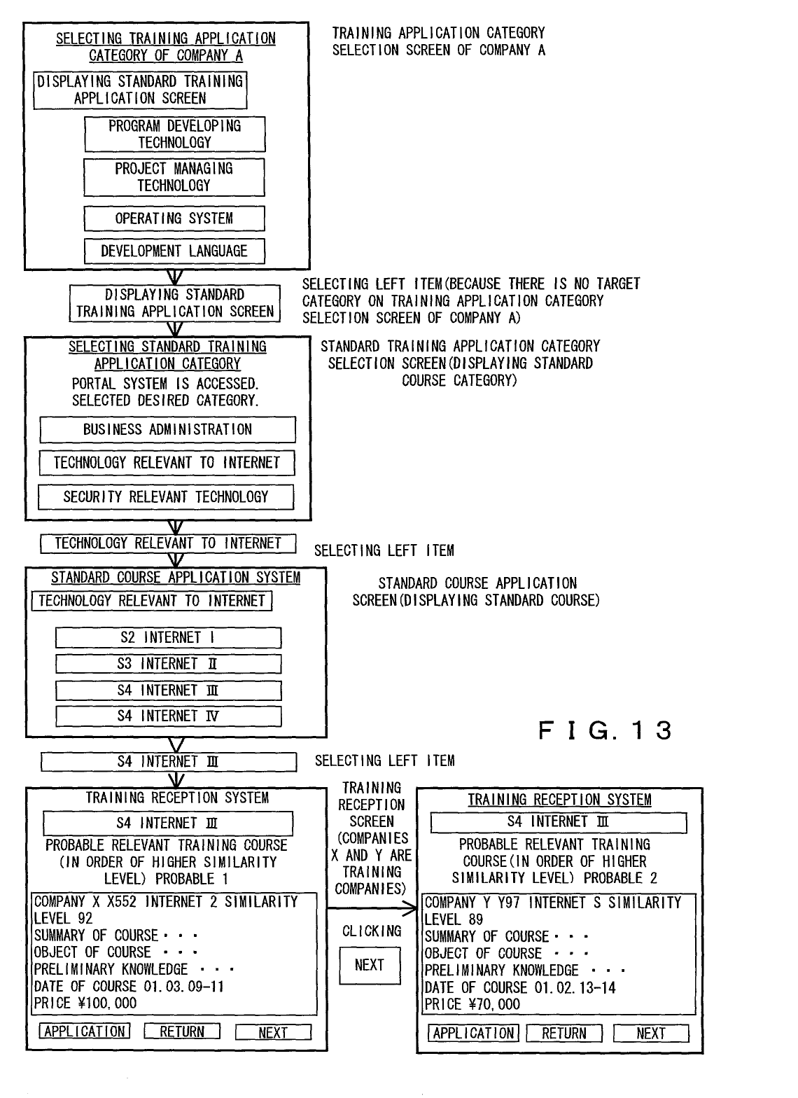

FIG. 13 shows an example of displaying the screen of the course selection process performed when there is no desired course in the information about the client company application system described above by referring to FIG. 12.

In FIG. 13, the training application category selection screen of the company A is first displayed. However, in this example, since there is no category desired by the applicant for training, for example, ‘Technology relevant to Internet’ shown in FIG. 6 on the selection screen, the applicant for training clicks and selects ‘displaying the standard training application screen’, and the training portal service server 20 shown in FIG. 3 is requested to display the screen corresponding to the selection result.

As a result, the standard training application category selection screen is displayed on the display screen of the client company server 21, and the applicant for training selects, for example, ‘Technology relevant to Internet’.

Corresponding to the selection result, the information about a plurality of standard courses belonging to the category of ‘Technology relevant to Internet’ is transmitted from the training portal service server 20 to the client company server 21, and displayed as a standard training application screen. On the screen, the applicant for training selects a desired course, for example, having the title ‘Internet III’ and the code ‘S4’ from among the standard courses. In this process, only the titles and codes of the courses are displayed so that the applicant for training can be informed of the contents of the courses by the titles only. However, it is obviously possible to display also the summaries, objects, etc. of the courses as necessary.

Corresponding to the selection result, a training course having the highest similarity level to the selected standard course is displayed on the training reception screen as a probable relevant training course. The applicant for training applies for any desired training by clicking a ‘next’ or ‘return’ button, checking the information about the courses sequentially displayed in order from the highest similarity level, and clicking the ‘application’ button with the desired course displayed on the screen.

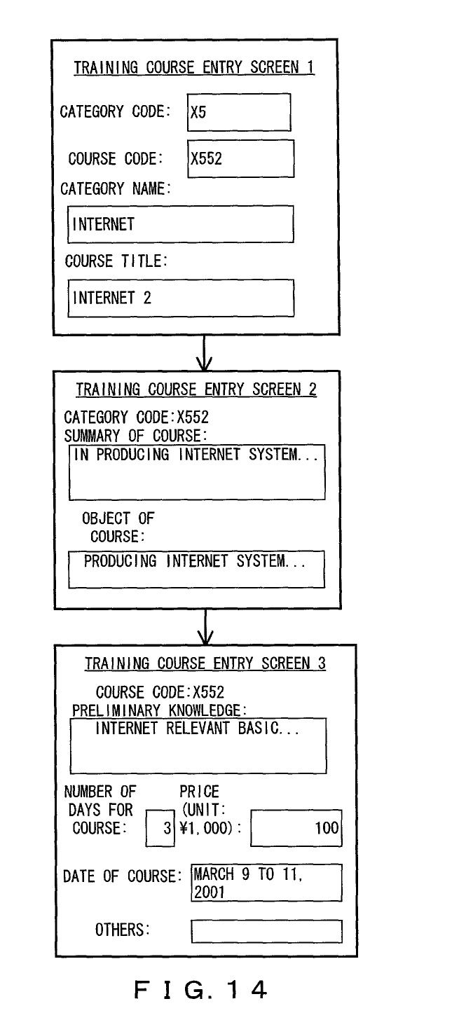

FIG. 14 shows an example of a screen display in the process of entering a training course from the training company server 22 shown in FIG. 3 to the training portal service server 20.

First, on the entry screen 1, a category code, a course code, the title of a category, and the title of a course are entered. On the entry screen 2, the summary of the course, and the object of the course are entered. On the entry screen 3, the preliminary knowledge, the number of days for the course, the price, the date, etc. are entered.

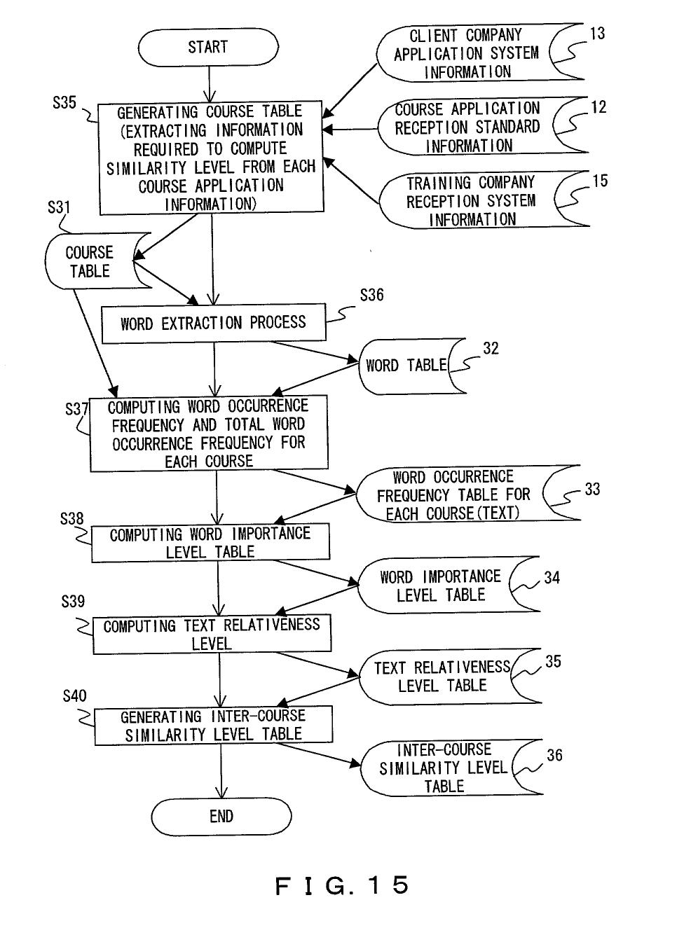

Described below are the computation of a similarity level performed when the course application standard individual conversion table 14 and the course reception standard individual conversion table 16 shown in FIG. 2 are generated. In the computation, the similarity levels are obtained according to the course application reception standard information 12, the client company application system information 13, and the training company reception system information 15 described by referring to FIGS. 7, 8, and 10. FIG. 15 is a flowchart of the detailed process of computing the similarity levels.

When the process starts as shown in FIG. 15, a course table generation process is first performed in step S35. In this process, the information necessary for the computation of similarity levels is extracted from the client company application system information 13, the course application reception standard information 12, and the training company reception system information 15, and a course table 31 is generated.

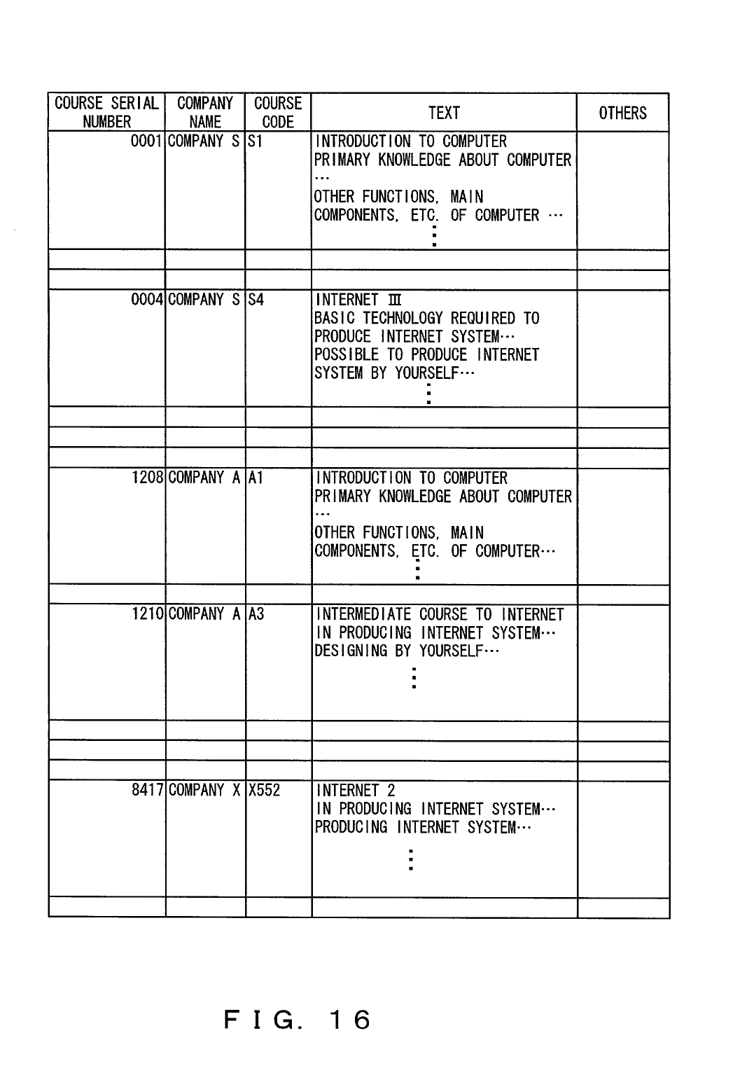

FIG. 16 shows an example of the contents stored in the course table. From each piece of information, the information about the name of a company, a course code, text, etc. is stored, and a serial number of a course is assigned to every course to be handled. The text is a group of information not essential to the computation of a similarity level such as a price, date, period, etc. extracted from the course application reception standard information 12, the client company application system information 13, and the training company reception system information 15. Therefore, the contents are collectively stored as the titles, summaries, objects, and preliminary knowledge of the courses.

In step S36 shown in FIG. 15, a word extraction process is performed on each piece of the text of the course table 31. In this process, for example, the word extraction algorithm disclosed in the following document is used.

Document: Japanese Patent Publication No.11- 134334 ‘Word Entry Apparatus and Storage Medium’

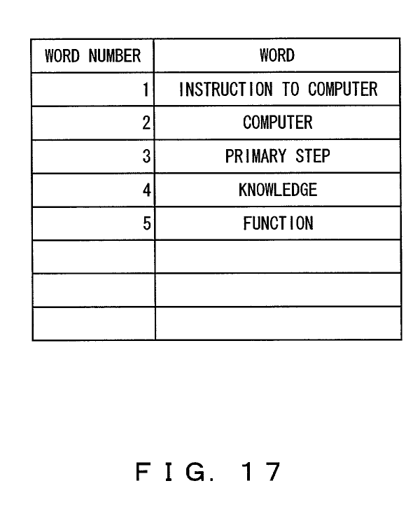

FIG. 17 shows an example of a word table 32 generated by the process in step S36.

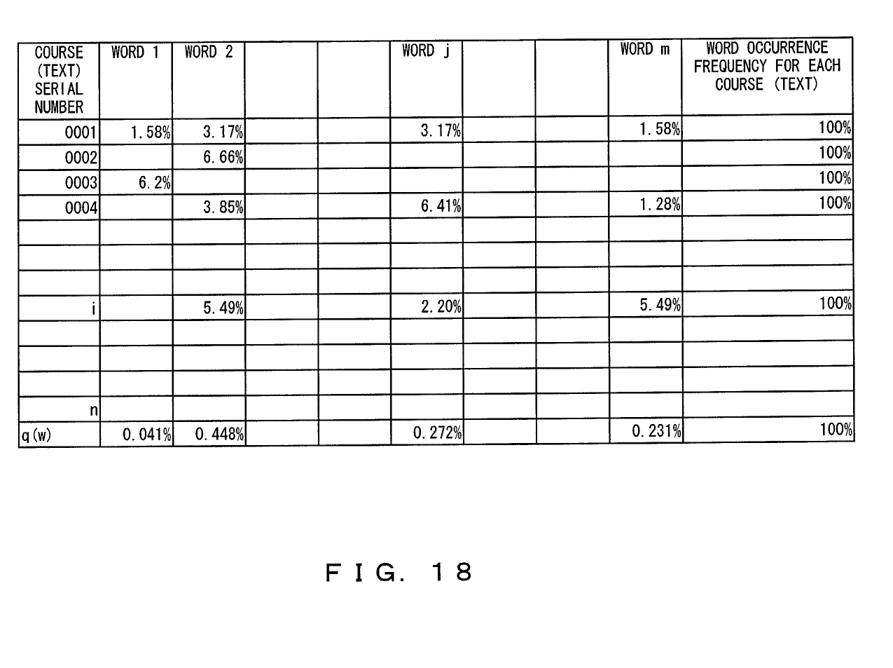

Then, in step S37 shown in FIG. 15, the processes of computing the word occurrence frequency for each course and the total word occurrence frequency are performed, and a word occurrence frequency table 33 is generated showing the word occurrence frequency for each course (text). FIG. 18 shows an example of the contents stored in the word occurrence frequency table. Except the bottom row, each row is assigned a serial number, and stores for each course the occurrence frequency of the words 1 through m in each text, that is, the value of P (t, w) described later, and a total word occurrence frequency of 100%. The bottom row indicates the value of q (w) described later.

In step S38 shown in FIG. 15, the computation process of a word importance level table is performed, and a word importance level table 34 is generated.

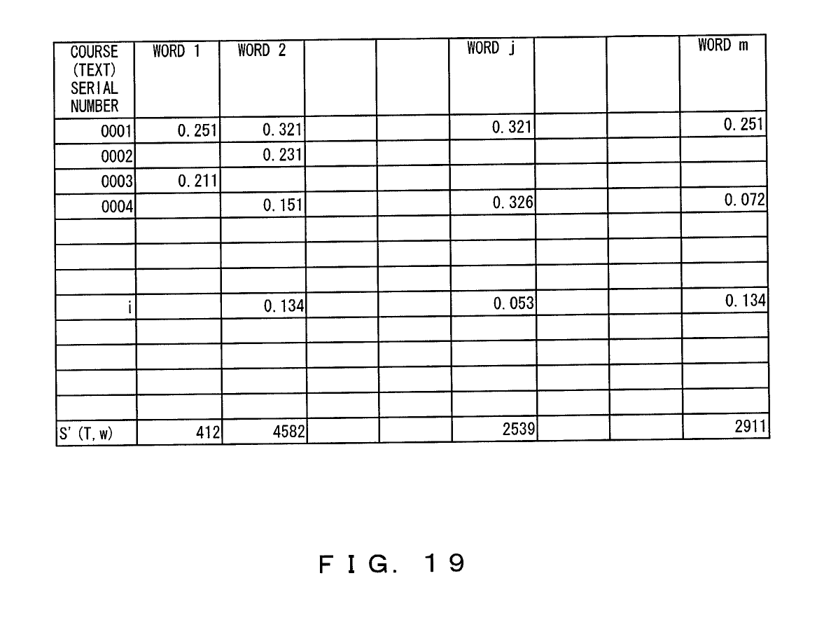

FIG. 19 shows an example of the contents stored in the word importance level table. Except the bottom row, each row stores the importance level of each word corresponding to each text, that is, S′ (t, w) described later. As a word importance level, a value obtained by normalizing a sum of second powers of the importance level of a word into 1 is used in each text.

Described below is the method of computing the importance level of a word. The importance level S (t, w) of a word w in one piece of text is computed by the following equation using the value obtained by dividing the occurrence probability p (t, w) of the word w in the text t, that is, the occurrence frequency of the word w in the text t, by a sum of the occurrence frequencies of all words in the text t, and the value obtained by dividing the occurrence probability q (w) of the word w in the set T of all text, that is, a sum of the occurrence frequency of the word w by a sum of the occurrence frequencies of all words. However, when the result is negative, the importance level is defined as 0.

S(t, w)=p (t, w)·log (p(t, w)/q(w)) (1)

As described above, the value of S′ (t, w) which is normalized such that the sum of second powers of the importance level of a word can be 1 in each text, is used in FIG. 19.

S′ (t, w) in the bottom row shown in FIG. 19 indicates the importance level of the word w in the set T of all text. The value is obtained as a sum of the importance levels of the word w in the text included in the set T by the following equation.

S′ (T,w)=ES(t,w) (2)

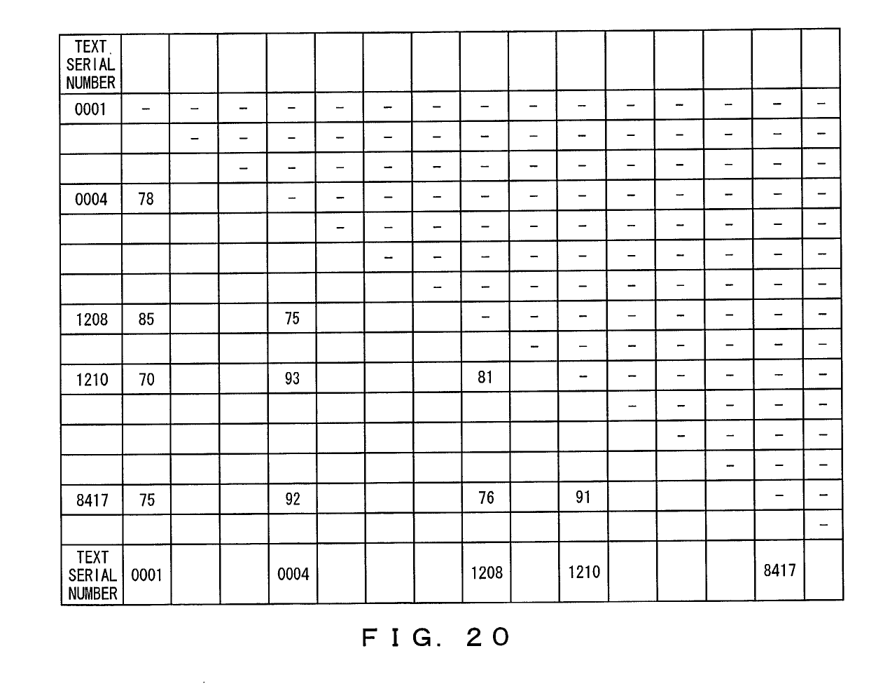

The process of computing the relativeness level of text is performed in step S39 shown in FIG. 15, and a text relativeness level table 35 is generated. FIG. 20 shows an example of the contents stored in the text relativeness level table. For example, 78 is stored as the relativeness level between the text of the text serial number 0004 and the text of the serial number 0001.

The relativeness level R (tl, t2) between the text tl and the text t2 is basically computed by the following equation. In this equation, w indicates a set of all words in the set T of all text.

$$R ( t1 , t2 ) = {\sum }_{w ∈ W} {S}^{′} ( t1 , w ) \cdot {S}^{′} ( t2 , w ) \qquad ( 3 )$$

As a value of a text relativeness level, the value is adjusted to be distributed between 0 and 1, multiplied by 100, represented by %, and stored in FIG. 20. The adjustment equation is obtained as follows.

$${R}^{′} ( t1 , t2 ) = \frac{R ( t1 , t2 )}{{Max}_{ti , tj ∈ T ( i \neq j )} [ R ( t1 , t2 ) ]} \times 100 \qquad ( 4 )$$

Max [R (ti, tj) is the maximum value of all values of text relativeness level values.

In step S40 shown in FIG. 15, the process of generating an inter-course similarity level table is performed as the last process, and a inter-course similarity level table 36 is generate, thereby terminating the process.

The value of the inter-course similarity level is basically the same as the text relativeness level, and can be obtained by the following equation.

L (Cu, Cv)=R′(tu, tv) (5)

where Cu, Cv are the course respectively corresponding to the text tu and tv.

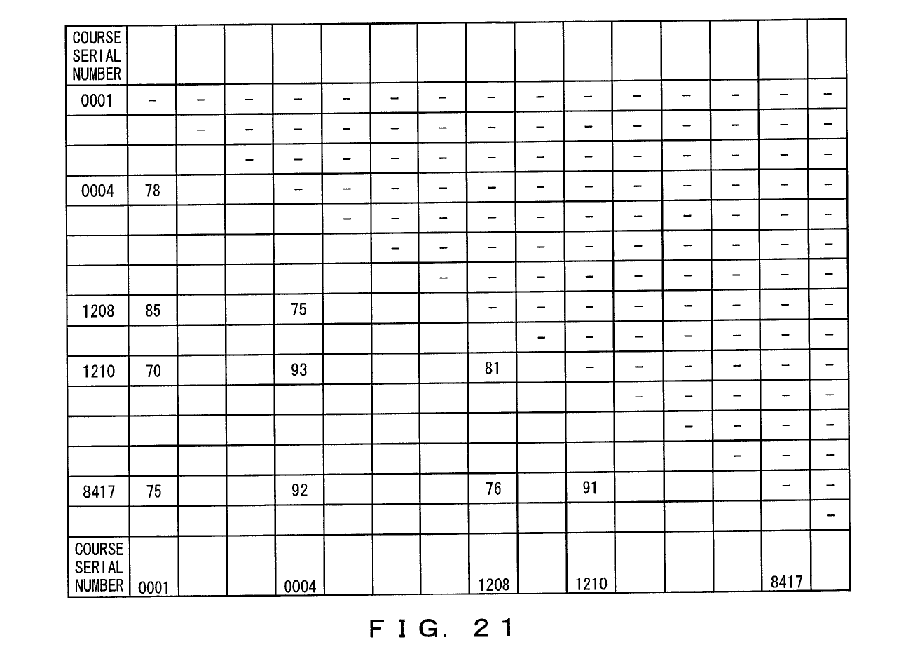

FIG. 21 shows an example of the contents stored in the inter-course similarity level table 36. The contents are the same as those of the text relativeness level table, and are different only in that substantially the same course serial numbers are used for the text serial numbers.

Then, the second embodiment of the present invention is described below.

In the above mentioned first embodiment, the training portal service server 20 shown in FIG. 3 contains the course application reception standard information 12, that is, the information about standard courses. From the standard courses, a standard course having the largest similarity level to the client company course is selected, and the final training course is selected from among the training courses having higher similarity levels to the selected standard course, thereby performing a two-stage process.

On the other hand, according to the second embodiment, the training portal service server 20 is not provided with the course application reception standard information 12, that is, the information about standard courses. In the second embodiment, training courses having higher similarity levels to the training course specified (selected) by an applicant for training are sequentially displayed in order from the highest similarity level. Then, the applicant for training selects any of the training courses, and the course is accepted.

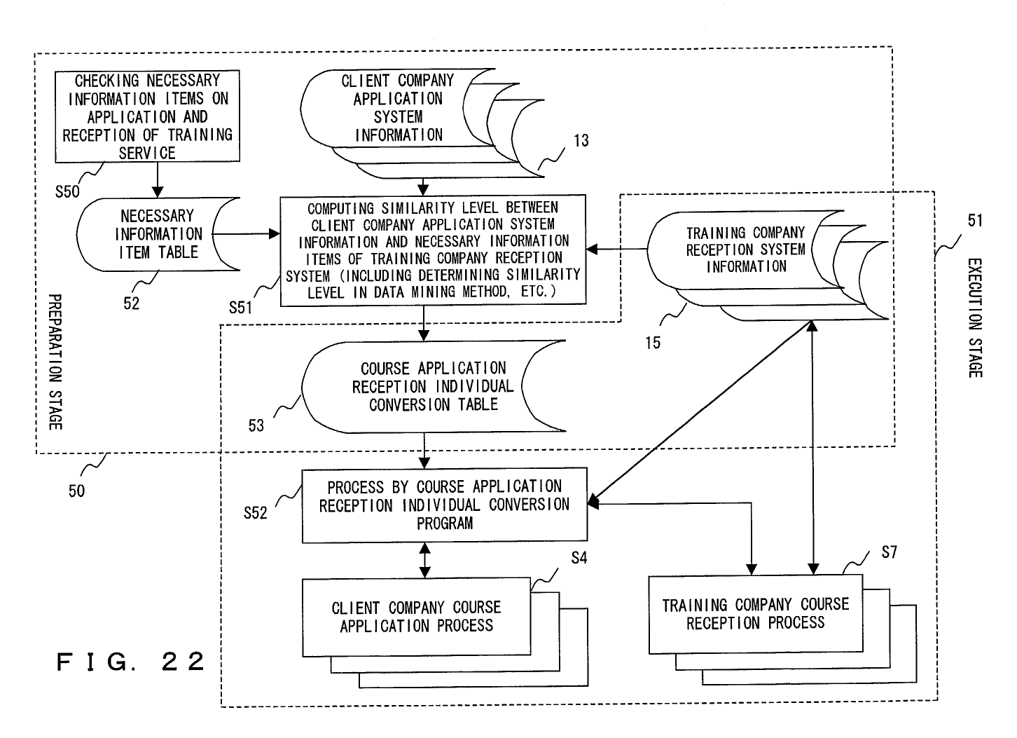

FIG. 22 shows the basic process according to the second embodiment.

As in the process shown in FIG. 2, the process comprises a preparation stage 50 and an execution stage 51. These processes are explained below, with the explanation centering on the portions different from the first embodiment.

First, in the preparation stage 50, necessary information items are checked for the application and the reception of a training service in step S50, and a necessary information item table 52 is generated. A necessary information item refers to an information item required to compute a similarity level between a client company course and a training course in the client company application system information 13 and the training company reception system information 15.

Then, in step S51, the computation of the similarity level between the necessary information items extracted from the client company application system information 13 and the training company reception system information 15 is performed in the data mining method, etc., and a course application reception individual conversion table 53 is generated. The table stores the correspondence, the similarity level, etc. between the client company course and the training course.

In the execution stage 51, as in the case of the client company course application process in step S4 shown in FIG. 2, a process is performed by the course application reception individual conversion program in step S52. In this step, the contents of the training courses having higher similarity levels to the client company course specified by the applicant for training are sequentially displayed in order from the highest similarity level using the course application reception individual conversion table 53. When the applicant for training selects a training course, the training company course reception process is performed in step S7.

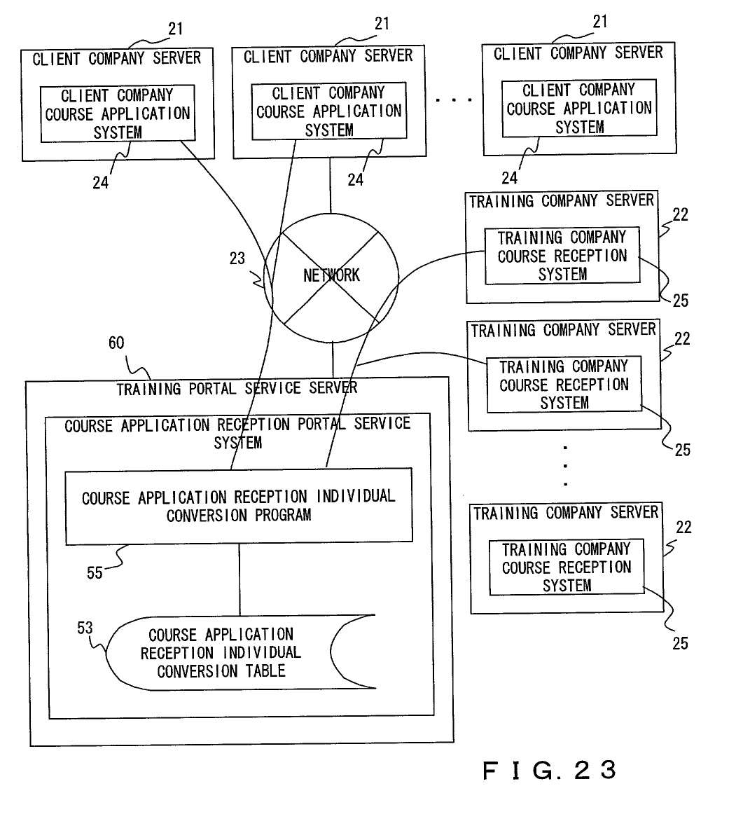

FIG. 23 shows the configuration of the entire system according to the second embodiment. The configuration is similar to that according to the first embodiment shown in FIG. 3, but a training portal service server 60 includes the course application reception individual conversion table 53 and a course application reception individual conversion program 55.

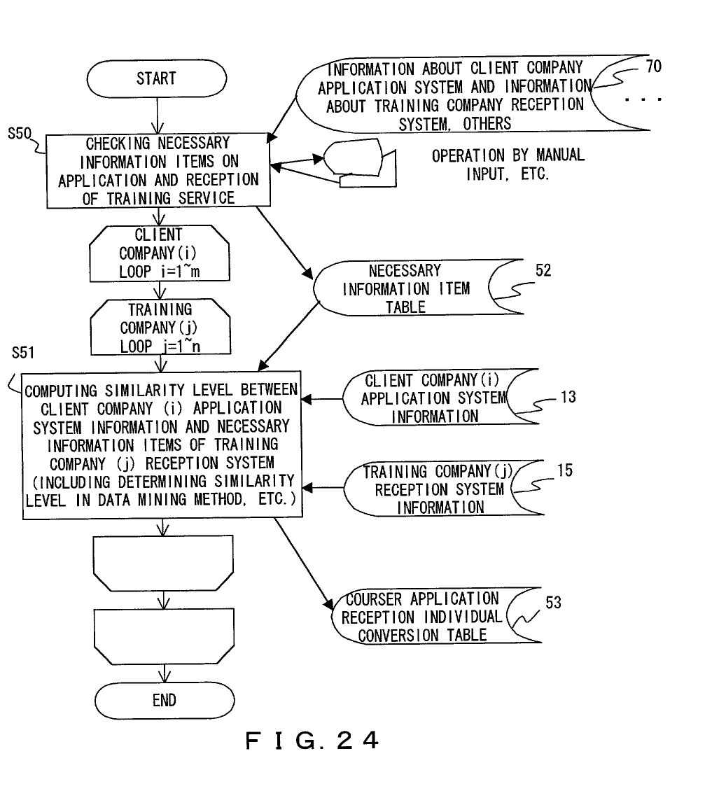

FIG. 24 is a flowchart of the process at the preparation stage 50 shown in FIG. 22.

In FIG. 22, when the process starts, the process of checking necessary information items is first performed in applying for and receiving a training service by an operation such as manual input, etc. according to the client company application system information and the training company reception system information, and the necessary information item table 52 is generated. The contents stored in the necessary information item table 52 are described later.

Then, in step S51, on a combination of a client company (i) i=1˜m and a training company (j) j=1˜n, a similarity level between the necessary information items of the client company (i) application system information 13 and the training company (j) reception system information 15 is computed using the contents of the necessary information item table 52, and the course application reception individual conversion table 53 is generated, thereby terminating the process at the preparation stage 50. An example of the configuration of the course application reception individual conversion table 53 is also described later.

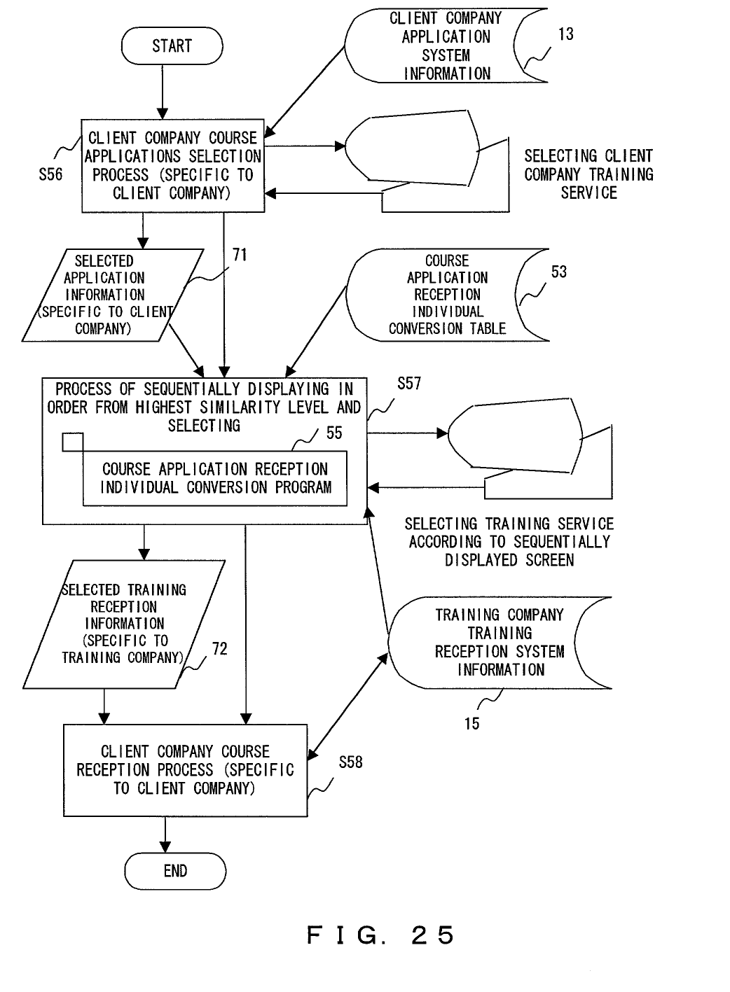

FIG. 25 is a flowchart of the process at the execution stage 51 shown in FIG. 22.

When the process starts as shown in FIG. 25, the client company course application selection process similar to the process in step S4 shown in FIG. 2 is performed. In this process, a client company course is selected by an applicant for training according to the client company application system information 13, and selected application information 71 is provided for the process in step S57.

In step S57, the selected application information 71, that is, the contents of the training courses having higher similarity levels to the selected client company course are sequentially displayed in order from the highest similarity level, and the applicant for training selects any of the training courses.

This process is performed by the course application reception individual conversion program 55 using the contents of the training company reception system information 15 and the course application reception individual conversion table 53.

Training reception information 72 including the information about the training course selected by the applicant for training is transmitted to the process in step S58. In step S58, the training company course reception process similar to the process in step S7 shown in FIG. 7 is performed, thereby terminating the process.

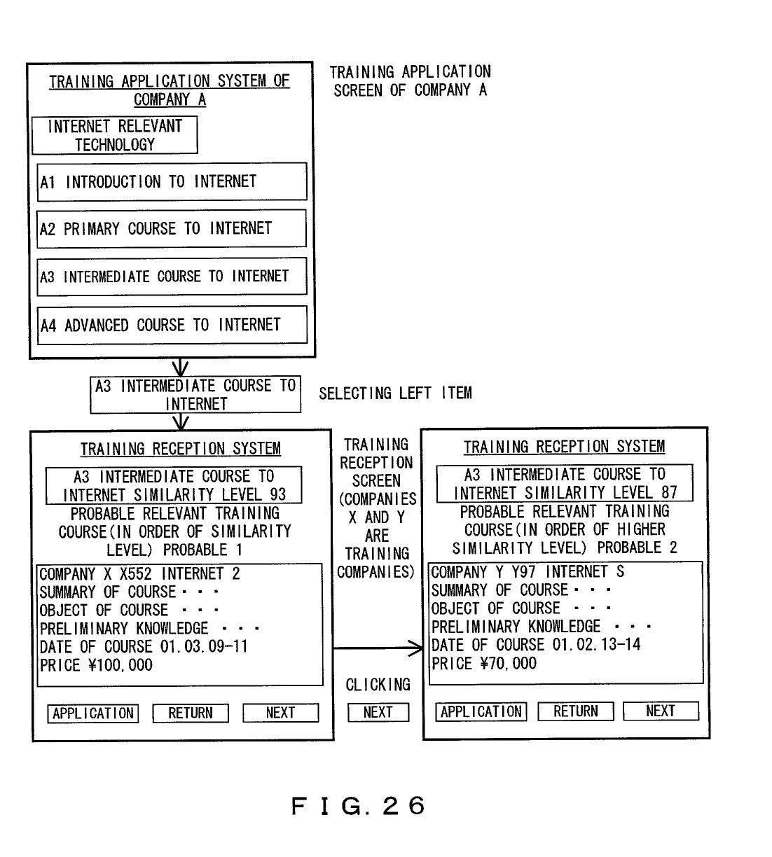

FIG. 26 shows an example of displaying the training application screen according to the second embodiment of the present invention.

In FIG. 26, if an applicant for training of the company A selects, for example, ‘A3 Intermediate Course to Internet’ from among the client company courses displayed on the training application screen of the company A, then the information about the training course having the highest similarity level to the selected client company course is displayed as a probable relevant training course on the training reception screen. If the applicant for training clicks the ‘next’ button on the screen to see the next probable relevant training course, then the information about the training course having the second highest similarity level is displayed as the second probable. The applicant for training displays a probable having the second highest similarity level by clicking the ‘next’ button, or displays the preceding probable by clicking the ‘return’ button so that the applicant can apply for a desired training course by clicking the ‘application’ button with the desired course information displayed.

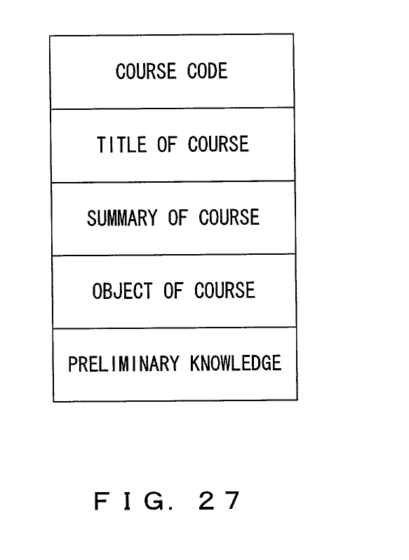

FIG. 27 shows an example of the contents stored in the necessary information item table.

In this table, course codes, titles of the courses, summaries of the courses, objects of the courses, and preliminary knowledge are stored. The similarity level is computed as described above also in the second embodiment. That is, the title of the courses, summaries of the courses, object of the courses, and preliminary knowledge are collectively processed as text. Although a course code is not directly used in the computation of a similarity level, it is essential data for correspondence with a course serial number as described above by referring to, for example, FIG. 16.

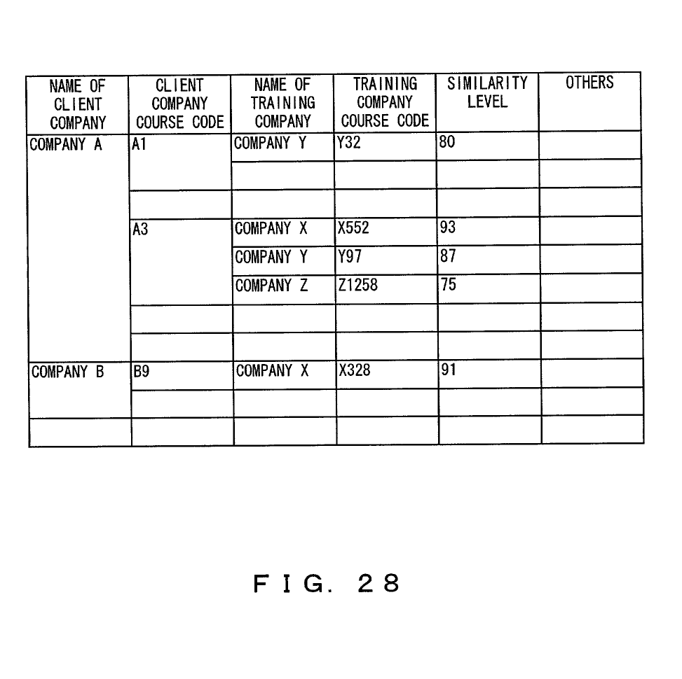

FIG. 28 shows an example of the contents stored in the course application reception individual conversion table 53.

In FIG. 28, a training course relevant to a client company is stored for each client company together with the name of a training company, the similarity level, etc.

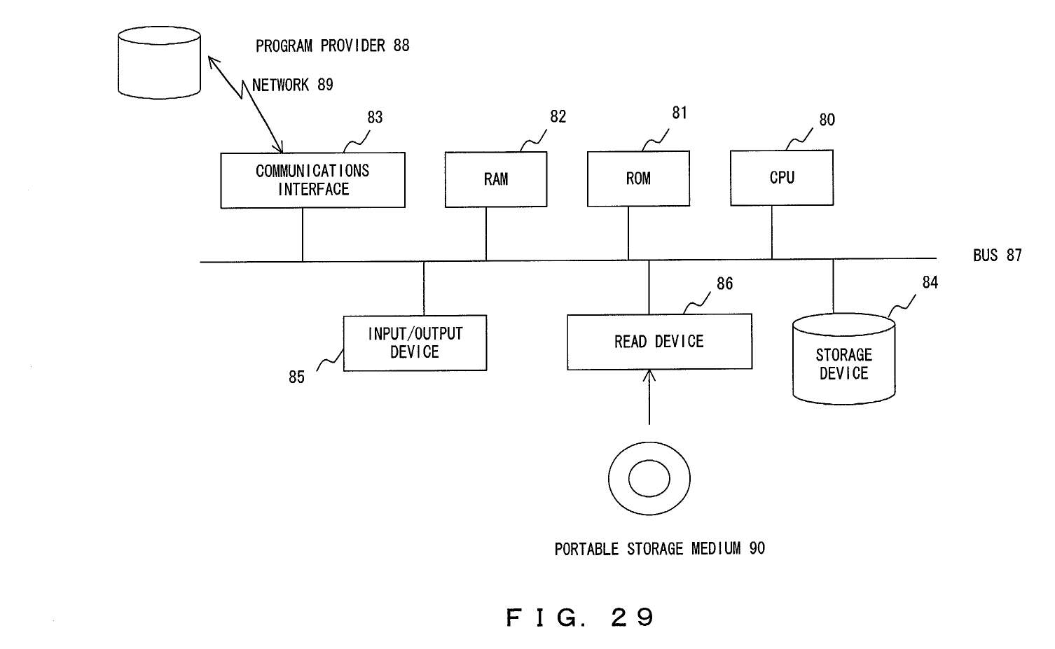

The training portal service apparatus and the training portal service method according to the present invention have been described above in detail, but the training portal service apparatus can obviously be configured by a general-purpose computer system. FIG. 29 is a block diagram of the configuration of the hardware environment of the computer system.

In FIG. 29, the computer system comprises a central processing unit (CPU) 80, read-only memory (ROM) 81, random-access memory (RAM) 82, a communications interface 83, a storage device 84, an input/output device 85, a read device 86 of a portable storage medium 90, and a bus 87 to which all the components are connected.

The storage device 84 can be various types of storage devices such as a hard disk, a magnetic disk, etc. A program and data for realizing the processes shown in the flowcharts in FIGS. 4, 5, 12, 24, and 25 are stored in the storage device 84 or the ROM 81, and the program is executed by the CPU 80, thereby realizing the functions of the training portal service apparatus and the training portal service system according to the embodiments of the present invention.

The program and data can be stored in, for example, the storage device 84 through a network 89 and the communications interface 83 from a program provider 88, or can be stored in the portable storage medium 90 for distribution and sale.

By setting the portable storage medium 90 in the read device 86, the program storing the CPU 80 is executed to perform each of the above mentioned processes in a computer system. The portable storage medium 90 can be various storage media such as CD-ROM, a floppy disk, an optical disk, a magneto-optic disk, etc. A program stored in such a storage medium is read by the read device 86, loaded into the RAM 82 or the storage device 84, and executed by the CPU to realize the functions of the training portal service apparatus.

As described above in detail, according to the present invention, an employee of a client company, etc. can easily select a training course from a training services of a plurality of training companies through a network such as Internet, etc. based on the similarity level between the training application information of a client company and the training reception information of the plurality of training companies.

A client company can select a training service from a large number of selection items. Furthermore, it is not necessary for a client company to perform an individual training application process with each training company, thereby considerably improving the operation efficiency.

Furthermore, a training company can extend its business without a special additional advertisement. Although it has conventionally been necessary to develop and provide a training course reception system for each client company, the system is not required. Therefore, the cost of developing and maintaining the system can be successfully reduced.

It is also not necessary for an employee of a client company to apply for a training course by switching the training application systems of a plurality of training companies when the employee applies for a training course, thereby easily applying for a training course with the plurality of training companies.

Additionally, the purposes of a client company and a training company match each other, and the ability of an employee can be successfully improved through training courses.

What is claimed is:

1. A training portal service apparatus for mediation of receiving an application for training between a client organization to which an applicant for training belongs and a training organization which provides a training service, comprising:
a first similarity level storage unit storing a first similarity level indicating a similarity level between one or more pieces of training application information about the client organization and plural pieces of standard training information about the training portal service;
a second similarity level storage unit storing a second similarity level indicating a similarity level between the plural pieces of standard training information and the plural pieces of training reception information; and
a training mediation unit allowing the applicant for training to select any of plural pieces of standard training information having higher first similarity levels to the training application information about the client organization specified by the applicant for training, and allowing the applicant for training to select any of the plural pieces of training reception information about the training organization having higher second similarity levels to the selected standard training information.

2. The apparatus according to claim 1, further comprising
a similarity level computation unit obtaining importance levels of words configuring each of the training application information, the standard training information, and the training reception information, and obtaining the first and second similarity levels using the importance levels of the words.

3. The apparatus according to claim 1, wherein
said first and second similarity levels are obtained in a data mining method.

4. A training portal service apparatus for mediation of receiving an application for training between a client organization to which an applicant for training belongs and a training organization which provides a training service, comprising:
a similarity level storage unit storing a similarity level between one or more pieces of training application information about the client organization and the plural pieces of training reception information about the training organization; and
a training mediation unit allowing the applicant for training to select any of the plural pieces of training reception information about the training organization about the plurality of training organizations having the higher similarity levels to the training application information about the client organization specified by the applicant for training.

5. The apparatus according to claim 4, further comprising
a similarity level computation unit obtaining importance levels of words configuring each of the training application information, the standard training information, and the training reception information, and obtaining the similarity levels using the importance levels of the words.

6. The apparatus according to claim 4, wherein said similarity level is obtained in a data mining method.

7. A training portal service apparatus for mediation of receiving an application for training between a client organization to which an applicant for training belongs and a training organization which provides a training service, comprising:
first similarity level storage means for storing a first similarity level indicating a similarity level between one or more pieces of training application information about the client organization and plural pieces of standard training information about the training portal service;
second similarity level storage means for storing a second similarity level indicating a similarity level between the plural pieces of standard training information and the plural pieces of training reception information; and
training mediation means for allowing the applicant for training to select any of plural pieces of standard training information having higher first similarity levels to the training application information about the client organization specified by the applicant for training, and allowing the applicant for training to select any of the plural pieces of training reception information about the training organization having higher second similarity levels to the selected standard training information.

8. A training portal service apparatus for mediation of receiving an application for training between a client organization to which an applicant for training belongs and a training organization which provides a training service, comprising:
similarity level storage means for storing a similarity level between one or more pieces of training application information about the client organization and the plural pieces of training reception information about the training organization; and
training mediation means for allowing the applicant for training to select any of the plural pieces of training reception information about the training organization about the plurality of training organizations having the higher similarity levels to the training application information about the client organization specified by the applicant for training.

9. A training portal service method for mediation of receiving an application for training between a client organization to which an applicant for training belongs and a training organization which provides a training service, comprising:
computing a first similarity level indicating a similarity level between one or more pieces of training application information about the client organization and plural pieces of standard training information;
computing a second similarity level indicating a similarity level between the plural pieces of standard training information and the plural pieces of training reception information;
allowing the applicant for training to select any of plural pieces of standard training information having higher first similarity levels to the training application information about the client organization specified by the applicant for training; and
allowing the applicant for training to select any of the plural pieces of training reception information about the training organization having higher second similarity levels to the selected standard training information.

10. A training portal service method for mediation of receiving an application for training between a client organization to which an applicant for training belongs and a training organization which provides a training service, comprising:
computing a similarity level between one or more pieces of training application information about the client organization and the plural pieces of training reception information about the training organization; and
allowing the applicant for training to select any of the plural pieces of training reception information about the training organization about the plurality of training organizations having the higher similarity levels to the training application information about the client organization specified by the applicant for training.

11. A computer-readable storage medium storing a program used to direct a computer for mediation of receiving an application for training between a client company to which an applicant for training belongs and a training company which provides a training service to perform a process comprising:
computing a first similarity level indicating a similarity level between one or more pieces of training application information about the client organization and plural pieces of standard training information;
computing a second similarity level indicating a similarity level between the plural pieces of standard training information and the plural pieces of training reception information;
allowing the applicant for training to select any of plural pieces of standard training information having higher first similarity levels to the training application information about the client organization specified by the applicant for training; and
allowing the applicant for training to select any of the plural pieces of training reception information about the training organization having higher second similarity levels to the selected standard training information.

12. A computer-readable storage medium storing a program used to direct a computer for mediation of receiving an application for training between a client company to which an applicant for training belongs and a training company which provides a training service to perform a process comprising:
computing a similarity level between one or more pieces of training application information about the client organization and the plural pieces of training reception information about the training organization; and
allowing the applicant for training to select any of the plural pieces of training reception information about the training organization about the plurality of training organizations having the higher similarity levels to the training application information about the client organization specified by the applicant for training.

13. A computer data signal embodied in a carrier wave and representing control software, said control software comprising the operation of:
computing a first similarity level indicating a similarity level between one or more pieces of training application information about the client organization and plural pieces of standard training information;
computing a second similarity level indicating a similarity level between the plural pieces of standard training information and the plural pieces of training reception information;
allowing the applicant for training to select any of plural pieces of standard training information having higher first similarity levels to the training application information about the client organization specified by the applicant for training; and
allowing the applicant for training to select any of the plural pieces of training reception information about the training organization having higher second similarity levels to the selected standard training information.

14. A computer data signal embodied in a carrier wave and representing control software, said control software comprising the operation of:
computing a similarity level between one or more pieces of training application information about the client organization and the plural pieces of training reception information about the training organization; and
allowing the applicant for training to select any of the plural pieces of training reception information about the training organization about the plurality of training organizations having the higher similarity levels to the training application information about the client organization specified by the applicant for training.
